(19) United States
(12) Patent Application Publication
(10) Pub. No.: US 2014/0293770 A1
(43) Pub. Date: Oct. 2, 2014

(54) METHODS FOR PERFORMING AND CONTROLLING RETRANSMISSION AND APPARATUS THEREOF

(71) Applicants: Jinhua Liu, Beijing (CN); Johan Bergman, Stockholm (SE); Johan Hultell, Solna (SE); Qingyu Miao, Beijing (CN)

(72) Inventors: Jinhua Liu, Beijing (CN); Johan Bergman, Stockholm (SE); Johan Hultell, Solna (SE); Qingyu Miao, Beijing (CN)

(73) Assignee: Telefonaktiebolaget L M Ericsson (publ), Stockholm (SE)

(21) Appl. No.: 14/356,965

(22) PCT Filed: Nov. 8, 2011
(86) PCT No.: PCT/CN2011/081910

§ 371 Date: May 8, 2014

(51) Int. Cl. H04L 1/18; H04W 72/04; H04L 5/00

(52) U.S. Cl. CPC H04L 1/1893; H04L 5/0053; H04W 72/046; H04W 88/08
USPC 370/216

(57) ABSTRACT

The present disclosure proposes methods for performing and controlling retransmission in a MIMO system and relevant network elements therefor. A method for performing retransmission includes transmitting one or more data blocks to the base station by using a first set of beams. The number of beams in the first set of beams corresponds to a first channel rank. Each beam of the first set of beams is generated by using at least one of pilot channel, data channel and control channel. The method further includes receiving a signal from the base station indicating erroneously received data blocks, and retransmitting the erroneously received data blocks in response to the signal.

### TECHNICAL FIELD

The disclosure relates to wireless communication systems, and more particularly, to methods for performing and controlling retransmission in a MIMO system and relevant network elements therefor.

### BACKGROUND

Unless otherwise indicated herein, the approaches described in this section are not prior art to the claims in this application and are not admitted to be prior art by inclusion in this section.

With the evolution of the High Speed Packet Access (HSPA), uplink Multiple Input Multiple Output (MIMO) transmissions have been proposed as a means improve uplink data rates and uplink coverage. At RAN#50 a work item on closed loop transmit diversity work item (Reference 1) and a study item on uplink MIMO (Reference 2) were initiated. UEs configured in uplink MIMO mode can be scheduled to transmit multiple data streams.

During Release 10, the third generation partnership project (3GPP) evaluated open loop beam forming and open loop antenna switching for uplink transmissions in WCDMA/HSPA. Both of these techniques are based on that a UE with multiple transmit antennas exploits the existing feedback, e.g. F-DPCH or E-HICH, to determine a suitable pre-coding vector in an autonomous fashion with the purpose to maximize the signal to noise plus interference ratio (SIR) at the receiving Node-B. Since the network is unaware of the applied pre-coding weights the Node-Bs will experience a discontinuity in the measured power when a change in pre-coding weights occurs. Recently there have been proposals for introducing closed loop transmit diversity (by closed loop transmit diversity, we refer to both closed loop beam forming and closed loop antenna switching) for WCDMA/HSPA. Contrary to the open loop techniques where the UE decides pre-coding weights closed loop techniques are based on that the network, e.g., the serving Node-B selects the suitable pre-coding vector with which the signal is multiplied. In order to signal the necessary feedback information from the network to the UE the Node-B can either rely on one of the existing physical channels (e.g., F-DPCH) or a new feedback channel could be introduced. A work item in which closed transmit diversity was started at RAN#50 plenary meeting (Reference 1).

Uplink multiple-input-multiple-output (MIMO) transmission is a related technique that has been proposed as a Rel-11 candidate for WCDMA/HSPA. A study item was started at RAN#50 plenary meeting (Reference 2). In uplink MIMO different data is transmitted from the virtual antennas (or antenna ports). It should be noted that closed loop beam forming can be viewed as a special case of uplink MIMO where no data is scheduled on one of the virtual antennas. MIMO technology is mainly beneficial in situations where the composite channel is strong and has high rank. Here we include the effects of transmit antenna(s), and the radio channel between the transmitting and receiving antennae in the term. However in situations where the rank of the composite channel is low (e.g. where there is a limited amount of multi-path propagation and cross polarized antennas are not used) and/or the path gain is weak, then single stream transmissions (beam forming techniques) are generally preferable. This means that the (theoretical) gains MIMO transmissions is marginal at low SIR operating point and that the inter-stream interference can be avoided (reduced) in case of single-stream transmissions.

FIG. 1 and FIG. 2 show two possible UE architectures for a UE configured in MIMO mode. In FIG. 3 the primary DPCCH (P-DPCCH) pilot and the secondary DPCCH (S-DPCCH) pilot are pre-coded with the same pre-coding vectors as used for pre-coding the other physical channels transmit on each respective beam. In FIG. 2 the P-DPCCH and S-DPCCH are not pre-coded.

In order to simplify the description below we here introduce the term beam which is defined as:

For pre-coded DPCCH pilots:
Primary beam: The beam generated by the channel set
   {P-DPCCH, P-E-DPCCH, HS-DPCCH, P-E-DPDCH}
Secondary beam: The beam generated by the channel set
   {S-DPCCH, S-E-DPCCH, S-E-DPDCH}

For non-pre-coded DPCCH pilots:
Primary beam: The beam generated by the channel set
   {P-E-DPCCH, HS-DPCCH, P-E-DPDCH}
Secondary beam: The beam generated by the channel set
   {S-E-DPCCH, S-E-DPDCH}

The number of beams that are available can be dynamically adapted to the number of orthogonal spatial channels estimated to be supported by the instantaneous radio conditions. This is known as channel rank adaptation. Assuming that two beams are available, the initial transmissions for packets belonging to the primary stream can be transmitted on the primary beam while the initial transmissions for packets belonging to the second stream can be transmitted on the secondary beam.

In HSUPA, synchronous hybrid automatic request (HARQ) is used. This implies that the relationship between a HARQ process and the HARQ-ACK feedback transmitted over E-HICH (indicating whether the transport block was successfully received) is indicated by means of a pre-defined timing relationship. This is illustrated FIG. 3, wherefrom it is evident that based on the reception time instant of the HARQ-ACK the UE can infer which HARQ process the HARQ-ACK feedback refers to.

In the most rudimentary HARQ schemes, data blocks that cannot be correctly decoded are discarded and retransmitted data blocks are decoded independently of the previous transmission attempts. However, even though the transmissions can not be correctly decoded there is still information present in the received signal. For HARQ techniques with soft combining the received data that cannot be successfully decoded is buffered and combined with the information that becomes available from the other (re)transmissions. The use of hybrid ARQ with soft combining allows the Node B to accumulate signal energy over multiple sub-frames. Thus the probability for correct decoding of retransmissions, is increased compared to the conventional ARQ.

For downlink MIMO transmissions, asynchronous HARQ is used. The HARQ process identity for each stream is thus transmitted in parallel with the data streams. This allows the UE receiver to distinguish between the different (re)transmissions of a data block by the HARQ process identity. Consequently, there is no problem to do downlink soft combining for (re)transmissions.

For legacy uplink transmissions where the UE only can transmit a single stream the HARQ process identity is not transmitted in uplink. Soft combining is thus performed based on the timing of HARQ process. For the case where the UE only transmits one transport block on a carrier soft combining can be performed based on the HARQ timing.

Also in case of multi-stream transmissions where the number of beams is always constant, soft combining of the first transmission and its retransmissions can be fairly straightforward since all these transmissions can take place within the same beam. The same principle as in the single stream case can be applied, i.e. that the soft combining is again uniquely defined by the HARQ timing within a beam.

However, in case of channel rank adaptive multi-stream transmissions, where the maximum number of beams is dynamically varied depending on the instantaneous radio channel characteristics, a beam may cease to exist between the time of e.g. the first transmission of a particular transport block and its retransmissions. It is not clear how to ensure that the first transmission of a particular transport block and its retransmissions are soft combined correctly by the Node B without signaling a HARQ process identity together with each (re)transmission.

### SUMMARY

The present disclosure proposes methods for performing and controlling retransmission in a MIMO system and relevant network elements therefor.

In an aspect of the disclosure, there is provided a method for performing retransmission at a User Equipment UE having at least two antennas in a wireless system comprising the UE and a base station having at least two antennas, the method comprising: transmitting one or more data blocks to the base station by using a first set of beams, the number of beams in the first set of beams corresponding to a first channel rank, each beam of the first set of beams being generated by using at least one of pilot channel, data channel and control channel; receiving a signal from the base station indicating erroneously received data blocks; and retransmitting the erroneously received data blocks in response to the signal.

In another aspect of the disclosure, there is proposed a method for controlling retransmission at a base station having at least two antennas in a wireless system comprising the base station and a User Equipment UE having at least two antennas, the method comprising: receiving one or more data blocks from the UE, the one or more data blocks being transmitted by the UE using a first set of beams, the number of beams in the first set of beams corresponding to a first channel rank, each beam of the first set of beams being generated by using at least one of pilot channel, data channel and control channel; detecting which of the one or more data blocks received from the UE are erroneously received; and sending a signal to the UE indicating the erroneously received data blocks so that the erroneously data blocks are retransmitted by the UE.

In yet another aspect of the present application, there is proposed a Use Equipment UE having at least two antennas for performing retransmission in a wireless system comprising the UE and a base station having at least two antennas, the UE comprising a radio circuit and a processing circuit, the processing circuit is configured to: transmit, using the radio circuit, one or more data blocks to the BS by using a first set of beams, the number of beams in the first set of beams corresponding to a first channel rank, each beam of the first set of beams being generated by using at least one of pilot channel, data channel and control channel; receive, using the radio circuit, a signal from the BS indicating erroneously received data blocks; and retransmit the erroneously received data blocks in response to the signal.

In still another aspect of the present application, there is proposed a base station having at least two antennas for controlling retransmission in a wireless system comprising the base station and a User Equipment UE having at least two antennas, the BS comprising a radio circuit and a processing circuit, the processing circuit is configured to: receive, using the radio circuit, one or more data blocks from the UE, the one or more data blocks being transmitted by the UE using a first set of beams, the number of beams in the first set of beams corresponding to a first channel rank, each beam of the first set of beams being generated by using at least one of pilot channel, data channel and control channel; detect which of the one or more data blocks received from the UE are erroneously received; and transmit, using the radio circuit, a signal to the UE indicating the erroneously received data blocks so that the erroneously data blocks are retransmitted by the UE.

### BRIEF DESCRIPTION OF THE DRAWINGS

The above and other objects, features and advantages of the present disclosure will be clearer from the following detailed description about the non-limited embodiments of the present disclosure taken in conjunction with the accompanied drawings, in which:

FIG. 1 illustrates an example of UE architecture of uplink MIMO where DPCCHs are pre-coded;

FIG. 2 illustrates an example of UE architecture of uplink MIMO where DPCCHs are not pre-coded;

FIG. 3 illustrates ACK/NACK feedback signaling in E-DCH;

FIG. 4 illustrates a wireless communication system in accordance with some embodiments of the present application;

FIG. 5 illustrates a sequential diagram of a method for performing and controlling retransmission in accordance with some embodiments of the present application;

FIG. 6 illustrates a retransmission scheme for beam bundled retransmission in accordance with an embodiment of the present application;

FIG. 7 illustrates a retransmission scheme for beam bundled retransmission in accordance with an embodiment of the present application;

FIG. 8 illustrates a retransmission scheme for beam bundled retransmission in accordance with an embodiment of the present application;

FIG. 9 illustrates a retransmission scheme for primary beam first retransmission in accordance with an embodiment of the present application;

FIG. 10 illustrates a retransmission scheme for primary beam first retransmission in accordance with an embodiment of the present application;

FIG. 11 illustrates a retransmission scheme for primary beam first retransmission in accordance with an embodiment of the present application;

FIG. 12 illustrates a retransmission scheme according to Example 3-2 of the present application;

FIG. 13 illustrates a retransmission scheme according to Example 3-4 of the present application;

FIG. 14 is a block diagram of an example UE configured according to some embodiments of the present application;

FIG. 15 illustrates a UE control circuit according to some embodiments of the present application;

FIG. 16 is a block diagram of an example base station configured according to some embodiments of the present application; and

FIG. 17 illustrates a base station control circuit according to some embodiments of the present application.

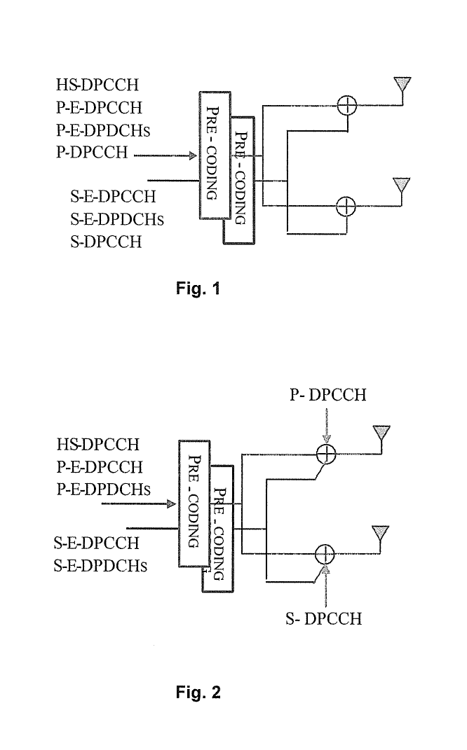

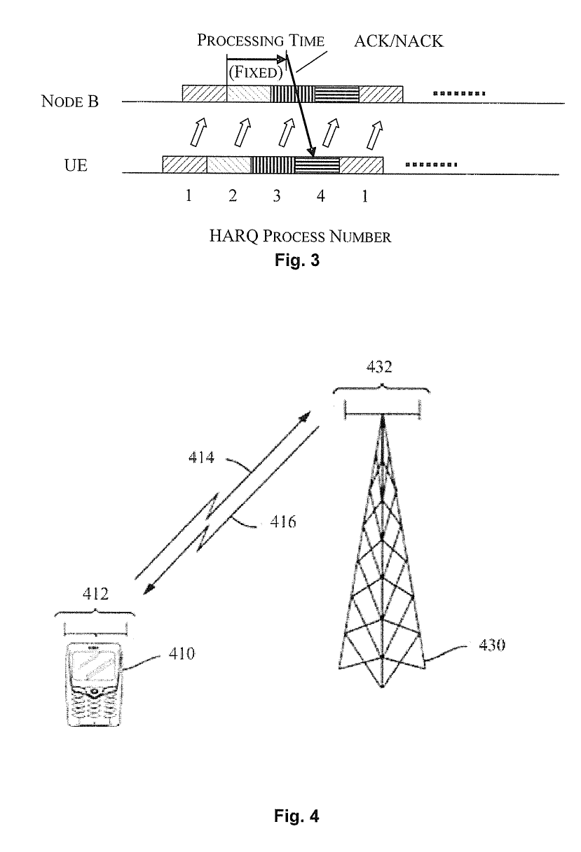

### DETAILED DESCRIPTION OF EMBODIMENTS

Various embodiments of the present disclosure are now described with reference to the drawings, wherein like reference numerals are used to refer to like elements throughout. In the following description, numerous specific details are set forth for purposes of explanation, in order to provide a thorough understanding of one or more embodiments. It will be evident to one of ordinary skill in the art, however, that some embodiments of the present disclosure may be implemented or practiced without one or more of these specific details. In other instances, well-known structures and devices are shown in block diagram form in order to facilitate describing embodiments.

While the following discussion focuses on retransmission strategy in a High-Speed Uplink Packet Access (HSUPA) system, the techniques described herein can be applied to various wireless communication systems configured for MIMO support in uplink transmission.

FIG. 4 illustrates components of a wireless network 400, including UE 410 and a base station 430. UE 410 communicates with base station 430 via at least two antennas 412, and base station 430 communicates with UE 410 via at least two antennas 432; individual ones or groups of these antennas are used to support multiple-input multiple-output (MIMO) transmission schemes. In the system illustrated in FIG. 4, UE 410 is communicating with base station 430 over an uplink (UE-to-base station) 414 and a downlink (base station-to-UE) 416.

Several of the embodiments are described herein in connection with a radio access terminal, such as UE 410 illustrated in FIG. 4. A radio access terminal, which communicates wirelessly with base stations in the wireless network, can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem.

Similarly, various embodiments are described herein in connection with a wireless base station, such as the base station 430 illustrated in FIG. 4. The wireless base station 430 communicates with access terminals and is referred to in various contexts as an access point, Node B, Evolved Node B (eNodeB or eNB) or some other terminology. Although the various base stations discussed herein are generally described and illustrated as though each base station is a single physical entity, those skilled in the art will recognize that various physical configurations are possible, including those in which the functional aspects discussed here are split between two physically separated units. Thus, the term “base station” is used herein to refer to a collection of functional elements (one of which is a radio transceiver that communicates wirelessly with one or more UEs), which may or may not be implemented as a single physical unit.

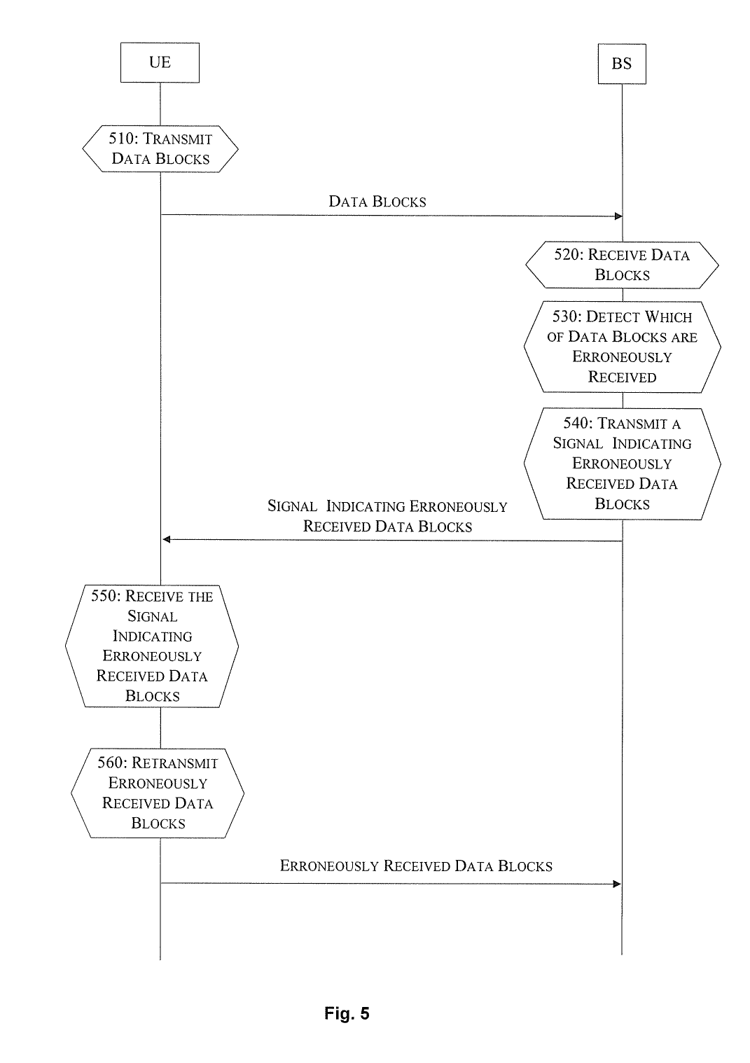

With FIG. 4 in mind, a method for performing and controlling retransmission according to an embodiment of the present application will be described in combination with FIG. 5. FIG. 5 shows a sequential diagram of such a method.

In step S510, UE 410 initially transmits one or more data blocks to base station 430 by using a first set of beams. The number of beams in the first set of beams corresponds to a first channel rank, and each beam of the first set of beams is generated by using at least one of pilot channel, data channel and control channel. In step S520, base station 430 receives the data blocks from UE 410, and then detects which of the data blocks are erroneously received in step 530. In step S540, base station 430 sends to UE 410 a signal indicating which data blocks are erroneously received. In step S550, UE 410 receives the signal, and in response to it, retransmits the erroneously received data blocks to base station 430 in step S560.

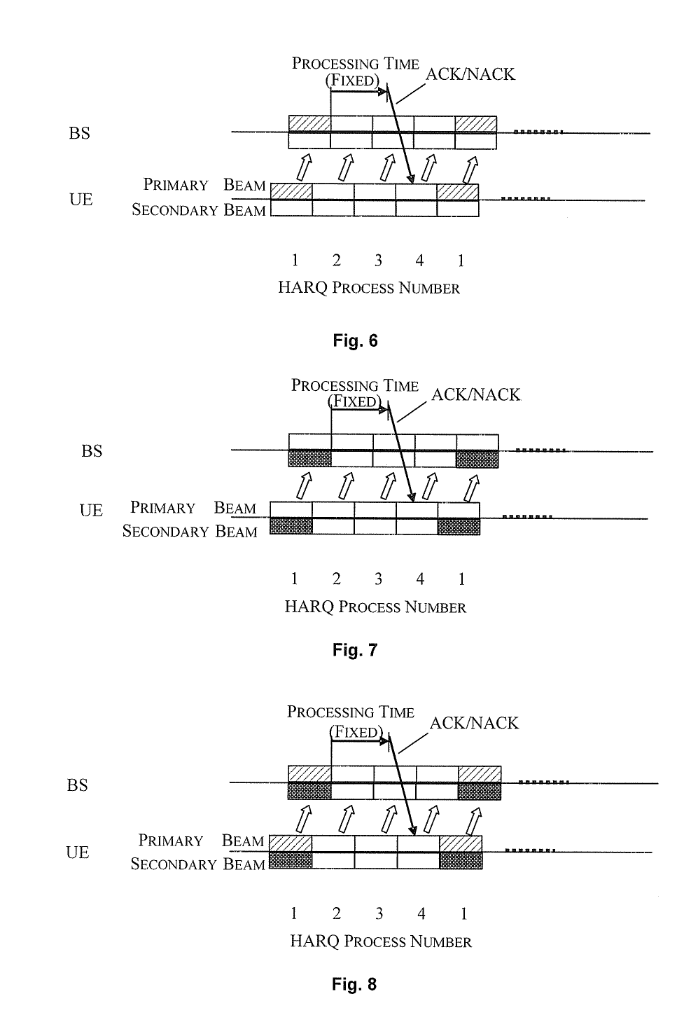

By way of non-limiting examples, respective steps of the above method will be further detailed with reference to FIGS. 6-11, which illustrate several exemplary data retransmission processes of the present application. While the following examples focus on retransmission in 2×2 uplink MIMO transmission, the techniques described herein can be applied to various uplink MIMO modes.

As well-known in the art, 2×2 uplink MIMO transmission may involve rank-1 transmission (i.e. the channel rank is equal to 1) and rank-2 transmission (i.e. the channel rank is 2), which usually mainly on the channel conditions and the like factors. For example, base station 430 may determine a channel rank based on the current channel conditions and then notify UE 410 of such a channel rank.

### EXAMPLE 1

### Beam Bundled Retransmission

According to this example, as illustrated in FIGS. 6-8, the retransmissions of a transport block are always performed on the same beam as the initial transmission.

It shall be noted that FIGS. 6-8 are depicted on an assumption of a rank-2 transmission where two transport blocks may be respectively transmitted on two beams, i.e. a primary beam and a secondary beam.

FIG. 6 shows a case where transmission associated with the primary beam fails and where the retransmissions associated with the primary beam is transmitted on the primary beam. As illustrated in FIG. 6, UE 410 firstly transmits two transport blocks by using the primary beam and the secondary beam, respectively, on HARQ Process 1. After a possibly fixed processing time, base station 430 determines that the transmission associated with the secondary beam succeeds while that associated with the primary beam fails, that is, the transport block transmitted by using the primary beam is erroneously received. Then, base station 430 signals of UE 410 such a case by means of ACK/NACK information. After receiving the ACK/NACK information, UE 410 retransmits the transport block, which was initially transmitted by using the primary beam, still using the primary beam.

FIG. 7 presents a case where the transmission associated with the primary beam succeeds while that associated with the secondary beam fails. As illustrated in FIG. 7, after receiving the ACK/NACK information from base station 430, UE 410 retransmits the transport block, which was initially transmitted by using the secondary beam, still using the secondary beam.

FIG. 8 illustrates a case where the transmission associated with the primary beam and that associated with the secondary beam both fail. As illustrated in FIG. 8, after receiving the ACK/NACK information from base station 430, UE 410 retransmits the transport block, which was initially transmitted by using the primary beam, still using the primary beam, and retransmits the transport block, which was initially transmitted by using the secondary beam, still using the secondary beam.

As illustrated in FIGS. 6-8, according to this embodiment, the retransmission of each erroneously received transport block is always performed by using the same beam as the initial transmission of the corresponding transport block. Then, the receiver of the base station assumes that the first transmission and its retransmissions take place within the same beam when it performs soft combining of these (re)transmissions.

The advantage of this method is that the beam mapping of the retransmission of transport blocks is simple. The disadvantage of this method is that the receiver should be designed to receive data in the secondary beam when there is retransmission in the secondary beam but no data is transmitted in the primary beam.

While the example as illustrated in FIGS. 6-8 is based on a rank-2 transmission of 2×2 uplink MIMO mode, the techniques described herein can be applied to various uplink MIMO modes.

### EXAMPLE 2

### Primary Beam First Retransmission

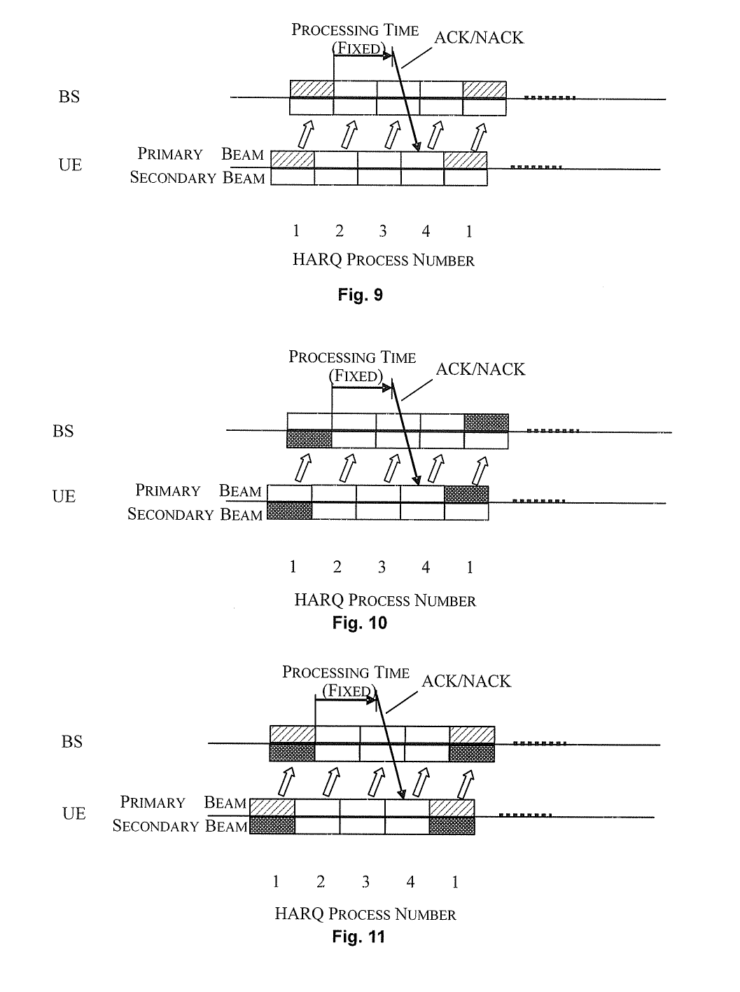

It shall be noted that FIGS. 9-11 are depicted on an assumption of a rank-2 transmission where two transport blocks may be respectively transmitted on two beams, i.e. a primary beam and a secondary beam.

According to this example, as illustrated in FIGS. 9-11, the primary beam is to be used with a higher priority than the secondary beam.

FIG. 9 shows, UE 410 firstly transmits two transport blocks by using the primary beam and the secondary beam, respectively, on HARQ Process 1. After a possibly fixed processing time, base station 430 determines that the transmission associated with the secondary beam succeeds while that associated with the primary beam fails, that is the transport block transmitted by using the primary beam is erroneously received. Then, base station 430 signals of UE 410 such a case by means of ACK/NACK information. After receiving the ACK/NACK information, UE 410 retransmits the transport block, which was initially transmitted by using the primary beam, by using the beam of higher priority, i.e. the primary beam in this example.

is FIG. 10 shows a case where the transmission associated with the primary beam succeeds while that associated with the secondary beam fails. As illustrated in FIG. 10, after receiving the ACK/NACK information from base station 430, UE 410 retransmits the transport block, which was initially transmitted by using the secondary beam, by using the beam of higher priority, i.e. the primary beam in this example.

FIG. 11 shows a case where the transmission associated with the primary beam and that associated with the secondary beam both fail. As illustrated in FIG. 11, after receiving the ACK/NACK information from base station 430, UE 410 retransmits the transport block, which was initially transmitted by using the primary beam, still using the primary beam, and retransmits the transport block, which was initially transmitted by using the secondary beam, still using the secondary beam. Then, the soft combining for the transport block transmitted using the primary beam is done over the primary beam and the soft combining of the transport block transmitted using the secondary beam is done over the secondary beam.

By way of a non-limiting example, the receiver in base station 430 can identify the retransmitted transport blocks based on the Redundancy Sequence Number (RSN) and do the soft combining for the retransmissions accordingly.

The advantage of this method is that the failed transport block has higher priority to use the primary beam so that the reliability of the retransmissions can be better guaranteed, while the disadvantage of this method is that complexity is increased for receiver design due to that the receiver has to distinguish the mapping between retransmission data and beam based on RSN. This method might also affect the outer loop power control if outer loop power control is done based on one of the streams and the power of another stream has some power offset compared to the fore-mentioned stream.

Although the example as illustrated in FIGS. 9-11 is based on a rank-2 transmission of 2×2 uplink MIMO mode, the techniques described herein can be applied to various uplink MIMO modes.

### EXAMPLE 3

### Rank Change Handling in Retransmissions

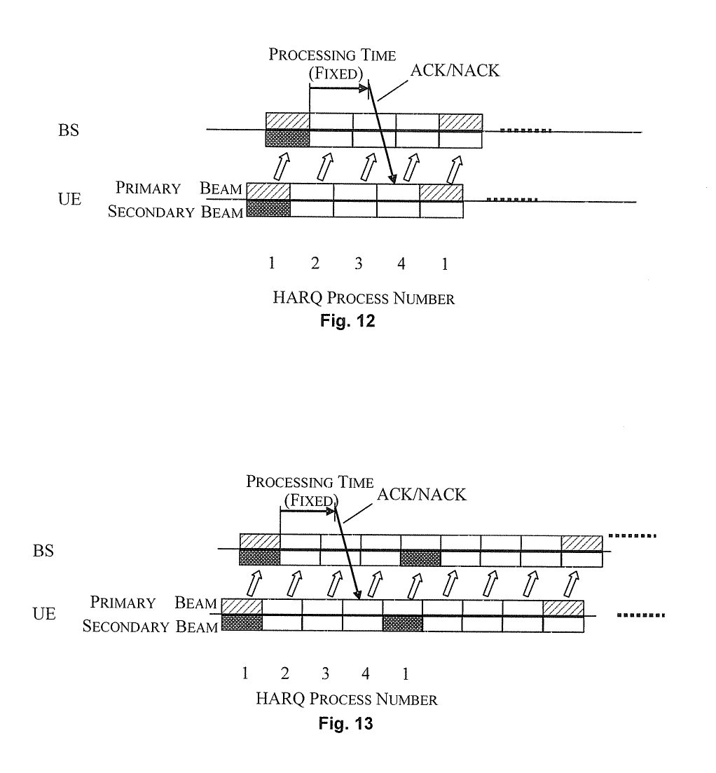

For the case where the transmission of one of the two transport blocks fails, its retransmission can be based on the methods described in the previous examples. However, when base station 430 determines a rank change based on the current channel conditions and schedules a rank-1 transmission in the sub-frame where the retransmissions ought to take place, the retransmission at the UE can be specifically handled in the following manners as illustrated in FIGS. 12 and 13.

### EXAMPLE 3-1

Although base station 430 determines a rank change based on the current channel conditions and schedules a rank-1 transmission in the sub-frame, base station 430 does not signal of UE 410 the changed channel rank, and UE 410 still uses the previous channel rank (i.e. rank-2 transmission in this embodiment) for retransmission. In practice, base station 430 measures the PCI delay and avoids to instructing UE 410 to use rank-1 transmission in the TTI for the retransmission of two failed transport blocks. The round trip PCI delay can be measured by base station 430 to record the time when to send certain PCI and the time when to use this PCI by the UE.

### EXAMPLE 3-2

Base station 430 signals UE 410 of the changed channel rank to order UE 410 use rank-1 transmission in the TTI for retransmission of two failed transport blocks on the primary beam and the secondary beam both. As shown in FIG. 12, after receiving the ACK/NACK information from base station 430 indicating the both failed transport blocks, UE 410 may retransmit the both failed transport blocks by only using the primary beam due to rank-1 transmission. Specifically, the transport block, which was initially transmitted by using the primary beam, may be retransmitted until it is correctly received before the retransmission of the transport block, which was initially transmitted by using the secondary beam. By way of a non-limiting example, the retransmission procedure may stop when the sum of retransmission attempts of both transport blocks exceeds a predetermined maximum allowed number of transmission attempts or both transport blocks are acknowledged. With this solution, the delay of the retransmission of the transport block that was initially transmitted by using the secondary beam is increased.

### EXAMPLE 3-3

Although base station 430 determines a rank change based on the current channel conditions, schedules a rank-1 transmission in the sub-frame and signals of UE 410 the changed channel rank to order UE 410 to use rank-1 transmission, UE 410 still retransmits by using the most recently received pre-coding vector for rank-2 transmissions to retransmit the failed transport blocks and indicated the used PCI in uplink.

### EXAMPLE 3-4

Base station 430 signals UE 410 of the changed channel rank to order UE 410 use rank-1 transmission in the TTI for retransmission of two failed transport blocks. As shown in FIG. 13, after receiving the ACK/NACK information from base station 430 indicating the both failed transport blocks, UE 410 may retransmit the both failed transport blocks alternately by only using the primary beam due to rank-1 transmission. Specifically, the transport block, which was initially transmitted by using the primary beam, is retransmitted first, following which the transport that was initially transmitted by using the secondary beam is retransmitted no matter whether the firstly retransmitted transport block is correctly received or not. By way of a non-limiting example, the retransmission stops when the sum of transmission attempts of both transport blocks exceeds a predetermined maximum allowed number of transmission attempts or both transport blocks are acknowledged (i.e. both transport blocks are correctly received).

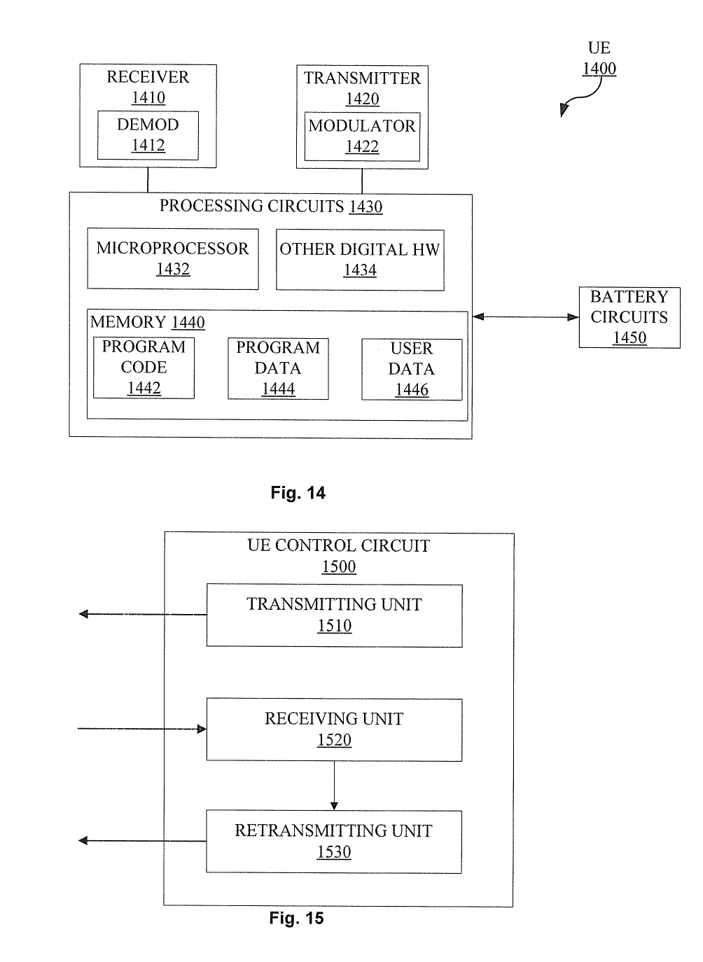

FIG. 14 is a block diagram of a wireless UE 1400 configured to participate in uplink retransmission in a wireless communication system, according to the techniques disclosed herein. In particular, UE 1400 may be configured to participate in the method illustrated in FIG. 5, or variants thereof. UE 1400 includes a receiver circuit 1410, which includes at least two antennas and various like radio-frequency components (not shown) and a demodulator 1412. Receiver 1410 processes radio signals received from one or more base stations and processes the signals, using known radio processing and signal processing techniques, for processing by processor circuits 1430. Processing circuits 1430 extract data from signals received via receiver 1410 and generate information for retransmission to the base station via transmitter circuit 1420. By a non-limiting example, processing circuits 1430 may determine which data blocks to be retransmitted based on information indicating which data blocks are erroneously received at the base station, such as ACK/NACK information received from the base station, and in responsive to this, retransmits the erroneously received data blocks to the base station. Like the receiver 1410, transmitter 1420 uses known radio processing and signal processing components and techniques, typically according to a particular telecommunications standard such as the 3GPP standard for Wideband CDMA and HSPA, and are configured to format digital data and generate and condition a radio signal for transmission over the air, for example initially transmit one or more data blocks to the base station.

Processing circuits 1430 comprise one or several microprocessors 1432, digital signal processors, and the like, as well as other digital hardware 1434 and memory circuit 1440. Memory 1440, which comprises one or several types of memory such as read-only memory (ROM), random-access memory, cache memory, flash memory devices, optical storage devices, etc., stores program code 1442 for executing one or more telecommunications and/or data communications protocols and for carrying out one or more of the techniques described herein. Memory 1440 further stores program data 1444, user data 1446 received from the base station and to be transmitted to the base station, and also stores various parameters, pre-determined threshold values, and/or other program data for controlling the operation of UE 1400. UE 1400 obviously includes various other feature that are not shown, in addition to the battery circuits 1450 pictured in FIG. 14; these features, such as user interface circuitry, positioning circuits, and the like, are well known to those skilled in the art and are therefore not illustrated.

In various embodiments, processing circuits 1430, using appropriate program code 1442 stored in memory 1440, are configured to implement one or more of the retransmission-related techniques described herein. Of course, not all of the steps of these techniques are necessarily performed in a single microprocessor or even in a single module. For instance, while a W-CDMA UE may include retransmission functionality that retransmits which the erroneously received data blocks, other systems may place retransmission or similar functionality in a physically separate unit.

Thus, FIG. 15 presents a more generalized view of a UE control circuit 1500 configured to carry out one or several of the flow-control techniques described herein. This UE control circuit 1500 may have a physical configuration that corresponds directly to a part of receiver 1410, transmitter 1420 and processing circuits 1430, for example, or may be embodied in two or more modules or units and may be implemented as hardware, software or a combination of hardware and software. In any case, however, UE control circuit 1500 is configured to implement at least three functions, which are pictured in FIG. 15 as transmitting unit 1510, receiving unit 1520 and retransmitting unit 1530.

Transmitting unit 1510 initially transmits one or more data blocks to the base station by using a first set of beams, the number of beams in the first set of beams corresponding to a first channel rank, each beam of the first set of beams being generated by using at least one of pilot channel, data channel and control channel. Receiving unit 1520 receives from the base station information indicating which data blocks are erroneously received at the base station, such as ACK/NACK information received from the base station. Then retransmitting unit 1530 retransmits the erroneously received data blocks to the base station in responsive to the information received by receiving unit 1520.

By way of a non-limiting example, retransmitting unit 1530 may retransmit the erroneously received data blocks comprises retransmitting each of the erroneously received data blocks by using the same beam of the first set of beams as the initial transmission of that data block. The advantage of this method is that the beam mapping of the retransmission of transport blocks is simple.

By way of a non-limiting example, retransmitting unit 1530 retransmits each of the erroneously received data blocks by using a beam, which is selected in a predetermined order of priority from the first set of beams. In this case, the receiver in the base station can identify the retransmitted transport blocks based on the Redundancy Sequence Number (RSN) and do the soft combining for the retransmissions accordingly. The advantage of this method is that the failed transport block has higher priority to use the primary beam so that the reliability of the retransmissions can be better guaranteed.

Alternatively, receiving unit 1520 further receives a second channel rank notified by the base station. By way of a non-limiting example, with the notified second channel rank, retransmitting unit 1530 retransmits the erroneously received data blocks by still using the first set of beams corresponding to the first channel rank. By way of another non-limiting example, retransmitting unit 1530 retransmits the erroneously received data blocks by using a second set of beams corresponding to the second channel rank, the second set of beams being generated by using at least one of pilot channel, data channel and control channel. By way of yet another non-limiting example, when the second channel rank is smaller than the first channel rank, retransmitting unit 1530 may either retransmit the erroneously received data blocks one by one in a predetermined order of priority, specifically, one erroneously received data block of higher priority is retransmitted until it is correctly received before retransmission of another erroneously received data block of lower priority, or retransmit the erroneously received data blocks one by one in a predetermined order of priority, specifically, one erroneously received data block of higher priority is retransmitted, following which another erroneously received data block of lower priority is retransmitted no matter whether retransmission of the erroneously received data block of higher priority succeeds or not.

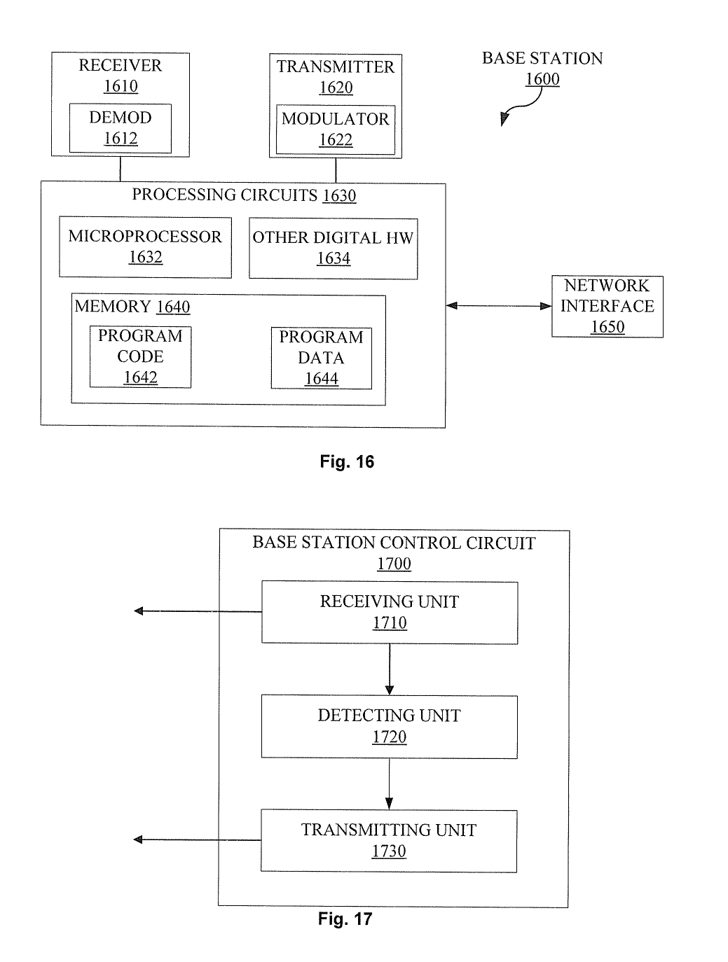

FIG. 16 is a block diagram of a wireless base station 1600 configured to participate in retransmission in a wireless communication system according to the techniques disclosed herein. In particular, base station 1600 may be configured to participate in the method as illustrated in FIG. 5, or variants thereof. Base station 1600 includes a receiver circuit 1610, which includes at least two antennas and various other radio-frequency components (not shown) and a demodulator circuit 1612. Receiver 1610 processes radio signals received from one or more wireless base station and processes the signals, using known radio processing and signal processing techniques, to convert the received radio signals into digital samples for processing by processor circuits 1630. More particularly, receiver 1610 is capable of receiving one or more data blocks simultaneously from the UE by means of its antennas. Processing circuits 1630 extract data from signals received via receiver 1610 and generate information for transmission to the UE via transmitter circuit 1620, including ACK NACK information. For example, processing circuits 1630 may detect which of data blocks transmitted from UEs are erroneously received, and then generate a signal indicating the erroneously received data blocks for transmission to the UEs by transmitter circuit 1620. Like the receiver 1610 and demodulator 1612, transmitter 1620 and modulator 1622 use known radio processing and signal processing components and techniques, typically according to one or more telecommunications standards, and are configured to format digital data and generate and condition a radio signal, from that data, for transmission over the air, for example transmit the signal indicating the erroneously received data blocks to the UE.

Processing circuits 1630 comprise one or several microprocessors 1632, digital signal processors, and the like, as well as other digital hardware 1634 and memory circuit 1640. Memory 1640, which may comprise one or several types of memory such as read-only memory (ROM), random-access memory, cache memory, flash memory devices, optical storage devices, etc., stores program code 1642 for executing one or more telecommunications and/or data communications protocols and for carrying out one or more of the techniques for signaling retransmission-related information described herein. Memory 1640 further stores program data 1644 as well as buffered traffic data received from UEs and from network interface 1650, and also stores various parameters, predetermined threshold values, and/or other program data for controlling the general operation of the base station 1600.

In some embodiments, processing circuits 1630, using appropriate program code 1642 stored in memory 1640, are configured to implement one or more of the techniques described herein. Of course, not all of the steps of these techniques are necessarily performed in a single microprocessor or even in a single module. For instance, while a W-CDMA NodeB may include detecting functionality that detects which of data blocks are erroneously received, other systems may place detecting or similar functionality in a physically separate unit.

Thus, FIG. 17 presents a more generalized view of a base station control circuit 1700 configured to carry out one or several of the signaling techniques discussed herein. This base station control circuit 1700 may have a physical configuration that corresponds directly to a part of receiver 1610, transmitter 1620 and processing circuits 1630, for example, or may be embodied in two or more modules or units, like the configuration illustrated in FIG. 17, and may be implemented as hardware, software or a combination of hardware and software. In any case, however, base station control circuit 1700 is configured to implement at least three functions, which are pictured in FIG. 17 as receiving unit 1710, detecting unit 1720, and transmitting unit 1730. Receiving unit 1710 receives one or more data blocks from the UE by using a first set of beams. Herein, the number of beams in the first set of beams corresponds to a first channel rank, and each beam of the first set of beams is generated by using at least one of pilot channel, data channel and control channel. Detecting unit 1720 detects which of the one or more data blocks received from the UE are erroneously received. Transmitting unit 1730 then transmits the detection result of detecting unit 1720 to the UE so as to indicate the erroneously received data blocks.

By way of a non-limiting example, base station control circuit 1700 may further comprises an ACK/NACK information generator (not shown), which is configured to produces ACK/NACK information for transmission to the UE in designated slots. Receiving unit 1710 receives data transmitted from the UE via multiple antennas. Detecting unit 1720 detects data transmitted received by receiving unit 1710. Based upon the MIMO configuration applied in the present application and the status of each detected stream (e.g., ACK, NACK), ACK/NACK information generator produces ACK/NACK information for transmission to the UE. Transmitting unit 1730 then transmits the ACK/NACK information to the UE in designated slots. It shall be noted that ACK/NACK information generator is optional here, and transmitting unit 1730 may transmit a signal indicating erroneously received data blocks in any known form to the UE.

By way of a non-limiting example, base station control circuit 1700 may further comprise an identifying unit, which is configured to identify the retransmitted streams based on the Redundancy Sequence Number (RSN) and does the soft combining for the retransmissions accordingly.

By way of a non--limiting example, base station control circuit 1700 may further comprise a channel rank determining unit (not shown), which is configured to determine a current channel rank based on the current channel conditions; and a notifying unit (not shown), which is configured to notify the UE of the current channel rank so that the erroneously received data blocks may be retransmitted by using a second set of beams corresponding to the current rank. For example, in a 2×2 MIMO system, when the wireless environment gets worse so that rank-2 transmission is not appropriate any more, a channel rank determining unit is may determine a new channel rank based on the current channel conditions and like factors, which is then notified to UE by the notifying unit so that the UE may retransmits the erroneously received data blocks to the base station.

With the retransmission schemes mentioned above, the present application may ensure that the first transmission of a particular transport block and its retransmissions are soft combined correctly by the Node B without signaling a HARQ process identity together with each (re)transmission.

Examples of several embodiments of the present disclosure have been described in detail above, with reference to the attached illustrations of specific embodiments. Because it is not possible, of course, to describe every conceivable combination of components or techniques, those skilled in the art will appreciate that the present disclosure can be implemented in other ways than those specifically set forth herein, without departing from essential characteristics of the disclosure. The present embodiments are thus to be considered in all respects as illustrative and not restrictive, and all modifications and variations that fall within the scope of the appended claims are intended to be embraced therein.

### ABBREVIATIONS

3GPP Third Generation Partnership Project

BS Base Station

CSI Channel State Information

DPCCH Dedicated Physical Control Channel

DPDCH Dedicated Physical Data Channel

E-DCH Enhanced Data Channel

E-DPDCH Enhanced DPDCH

E-DPCCH Enhanced DPCCH

E-HICH E-DCH HARQ Acknowledgement Indicator Channel

F-DPCH Fractional Dedicated Physical Channel

HARQ Hybrid Automatic Repeat Request

HS-DPCCH High Speed Downlink Physical Control Channel

HSPA High Speed Packet Access

MIMO Multiple Input Multiple Output

PCI Pre-Coding Vector Index

P-DPCCH Primary DPCCH

RSN Redundancy Sequence Number

S-DPCCH Secondary DPCCH

S-E-DPDCH Secondary E-DPDCH

S-E-DPCCH Secondary S-E-DPCCH

SIR Signal to Interference plus Noise Ratio

TTI Transmit Time Interval

UE User Equipment

WCDMA Wideband Code Division Multiple Access

### REFERENCES

[1] RP-101438, “Uplink (Open-Loop and Closed-Loop) Transmit Diversity for HSPA”

[2] RP-101432, “UL MIMO for HSPA”

1. A method for performing retransmission at a User Equipment UE having at least two antennas in a wireless system comprising the UE and a Base Station BS having at least two antennas, the method comprising:
transmitting one or more data blocks to the BS by using a first set of beams, the number of beams in the first set of beams corresponding to a first channel rank, each beam of the first set of beams being generated by at least one of pilot channel, data channel and control channel;
receiving a signal from the BS indicating erroneously received data blocks; and
retransmitting the erroneously received data blocks in response to the signal.

2. The method according to claim 1, wherein retransmitting the erroneously received data blocks comprises retransmitting each of the erroneously received data blocks by using the same beam of the first set of beams as the initial transmission of that data block.

3. The method according to claim 1, wherein retransmitting the erroneously received data blocks comprises:
retransmitting each of the erroneously received data blocks by using a beam, which is selected in a predetermined order of priority from the first set of beams.

4. The method according to claim 1, wherein when the BS determines a second channel rank based on the current channel conditions, retransmitting the erroneously received data blocks comprises:
retransmitting the erroneously received data blocks by using the first set of beams.

5. The method according to claim 1, wherein when the BS determines a second channel rank based on the current channel conditions, retransmitting the erroneously received data blocks comprises:
retransmitting the erroneously received data blocks by using a second set of beams, the number of beams in the second set of beams corresponding to the second channel rank, each beam of the second set of beams being generated by using at least one of pilot channel, data channel and control channel.

6. The method according to claim 4, wherein the second channel rank is smaller than the first channel rank.

7. The method according to claim 6, wherein the erroneously received data blocks are retransmitted one by one in a predetermined order of priority, one erroneously received data block of higher priority being retransmitted until it is correctly received before retransmission of another erroneously received data block of lower priority.

8. The method according to claim 6, wherein the erroneously received data blocks are retransmitted one by one in a predetermined order of priority, one erroneously received data block of higher priority being retransmitted, following which another erroneously received data block of lower priority is retransmitted no matter whether retransmission of the erroneously received data block of higher priority succeeds or not.

9. A method for controlling retransmission at a BS having at least two antennas in a wireless system comprising the BS and a User Equipment UE having at least two antennas, the method comprising:
receiving one or more data blocks from the UE, the one or more data blocks being transmitted by the UE using a first set of beams, the number of beams in the first set of beams corresponding to a first channel rank, each beam of the first set of beams being generated by using at least one of pilot channel, data channel and control channel;
detecting which of the one or more data blocks received from the UE are erroneously received; and
transmitting a signal to the UE indicating the erroneously received data blocks so that the erroneously data blocks are retransmitted by the UE.

10. The method according to claim 9, further comprising:
receiving the erroneously data blocks retransmitted by the UE; and
identifying the retransmitted erroneously received data blocks based on Redundancy Sequence Number RSN.

11. The method according to claim 9, further comprising:
determining a second channel rank based on the current channel conditions; and
notifying the UE of the second channel rank so that the erroneously received data blocks are retransmitted by using a second set of beams, the number of beams in the first set of beams corresponding to the second channel rank, each beam of the second set of beams being generated by using at least one of pilot channel, data channel and control channel.

12. The method according to claim 11, wherein the second channel rank is smaller than the first channel rank.

13. The method according to claim 12, wherein the erroneously received data blocks are retransmitted one by one in a predetermined order of priority, one erroneously received data block of higher priority being retransmitted until it is correctly received by the BS before retransmission of another erroneously received data block of lower priority.

14. The method according to claim 12, wherein the erroneously received data blocks are retransmitted alternatively, one erroneously received data block of higher priority being firstly retransmitted, following which another erroneously received data block of lower priority is retransmitted no matter whether retransmission of the erroneously received data block of higher priority succeeds or not.

15. A User Equipment UE having at least two antennas for performing retransmission in a wireless system comprising the UE and a Base Station BS having at least two antennas, the UE comprising a radio circuit and a processing circuit, the processing circuit is configured to:
transmit, using the radio circuit, one or more data blocks to the BS by using a first set of beams, the number of beams in the first set of beams corresponding to a first channel rank, each beam of the first set of beams being generated by using at least one of pilot channel, data channel and control channel;
receive, using the radio circuit, a signal from the BS indicating erroneously received data blocks; and
retransmit the erroneously received data blocks in response to the signal.

16. The UE according to claim 15, wherein the processing circuit is configured to retransmit each of the erroneously received data blocks by using the same beam of the first set of beams as the initial transmission of that data block.

17. The UE according to claim 15, wherein the processing circuit is configured to retransmit the erroneously received data blocks retransmits each of the erroneously received data blocks by using a beam, which is selected in a predetermined order of priority from the first set of beams.

18. The UE according to claim 15, wherein the processing circuit is configured, when a second channel rank is determined by the BS based on the current channel conditions, to retransmit the erroneously received data blocks retransmits the erroneously received data blocks by using the first set of beams.

19. The UE according to claim 15, wherein the processing circuit is configured, when a second channel rank is determined by the BS based on the current channel conditions, to retransmit the erroneously received data blocks retransmits the erroneously received data blocks by using a second set of beams, the number of beams in the second set of beams corresponding to the second channel rank, each beam of the second set of beams being generated by using at least one of pilot channel, data channel and control channel.

20. The UE according to claim 18, wherein the second channel rank is smaller than the first channel rank.

21. The UE according to claim 20, wherein the processing circuit is configured so that the erroneously received data blocks are retransmitted one by one in a predetermined order of priority, one erroneously received data block of higher priority being retransmitted until it is correctly received before retransmission of another erroneously received data block of lower priority.

22. The UE according to claim 20, wherein the processing circuit is configured so that the erroneously received data blocks are retransmitted one by one in a predetermined order of priority, one erroneously received data block of higher priority being retransmitted, following which another erroneously received data block of lower priority is retransmitted no matter whether retransmission of the erroneously received data block of higher priority succeeds or not.

23. A Base Station BS having at least two antennas for controlling retransmission in a wireless system comprising the BS and a User Equipment UE having at least two antennas, the BS comprising a radio circuit and a processing circuit, the processing circuit is configured to:
receive, using the radio circuit, one or more data blocks from the UE, the one or more data blocks being transmitted by the UE using a first set of beams, the number of beams in the first set of beams corresponding to a first channel rank, each beam of the first set of beams being generated by using at least one of pilot channel, data channel and control channel;
detect which of the one or more data blocks received from the UE are erroneously received; and
transmit, using the radio circuit, a signal to the UE indicating the erroneously received data blocks so that the erroneously data blocks are retransmitted by the UE.

24. The BS according to claim 23, the processing circuit is configured to:
receive, using the radio circuit, the erroneously data blocks retransmitted by the UE; and
identify, using the radio circuit, the retransmitted erroneously received data blocks based on Redundancy Sequence Number RSN.

25. The BS according to claim 23, the processing circuit is configured to:
determine a second channel rank based on the current channel conditions; and
notify, using the radio circuit, the UE of the second channel rank so that the erroneously received data blocks are retransmitted by using a second set of beams, the number of beams in the first set of beams corresponding to the second channel rank, each beam of the second set of beams being generated by using at least one of pilot channel, data channel and control channel.

26. The BS according to claim 25, wherein the second channel rank is smaller than the first channel rank.

27. The BS according to claim 26, wherein the erroneously received data blocks are retransmitted one by one in a predetermined order of priority, one erroneously received data block of higher priority being retransmitted until it is correctly received by the BS before retransmission of another erroneously received data block of lower priority.

28. The BS according to claim 26, wherein the erroneously received data blocks are retransmitted alternatively, one erroneously received data block of higher priority being firstly retransmitted, following which another erroneously received data block of lower priority is retransmitted no matter whether retransmission of the erroneously received data block of higher priority succeeds or not.
